(19) United States
(12) Patent Application Publication
(10) Pub. No.: US 2026/0364933 A1
(43) Pub. Date: Nov. 19, 2026

(54) SENSOR PAD MANUFACTURING APPARATUS AND METHOD

(71) Applicants: KOMOS CO., LTD., Hwaseong-si Gyeonggi-do (KR); DGK, Hanam-si Gyeonggi-do (KR)

(72) Inventors: In Chul YOO, Hwaseong-si Gyeonggi-do (KR); Hyeoung Seok SONG, Suwon-si Gyeonggi-do (KR); Seok Hwan JI, Suwon-si Gyeonggi-do (KR); Dae Jin KO, Hanam-si Gyeonggi-do (KR)

(73) Assignees: KOMOS CO., LTD., Hwaseong-si Gyeonggi-do (KR); DGK, Hanam-si Gyeonggi-do (KR)

(21) Appl. No.: 19/402,062

(22) Filed: Nov. 26, 2025

(30) Foreign Application Priority Data
May 15, 2025 (KR) 10-2025-0062992

(51) Int. Cl. B32B 37/10; B32B 5/02; B32B 27/12; B32B 37/18; B32B 38/00; B32B 41/00

(52) U.S. Cl. CPC B32B 37/10; B32B 5/024; B32B 27/12; B32B 37/18; B32B 38/0012; B32B 41/00; B32B 2307/204; B32B 2457/00

(57) ABSTRACT

Provided are an apparatus and a method for manufacturing a sensor pad. The apparatus for manufacturing the sensor pad includes a fabric supply configured to supply, at a predetermined speed, a fabric with a sensor layer that is woven on one side and a shield layer that is woven on the other side with respect to a center line, a guide unit configured to guide the sensor layer and the shield layer to be naturally combined as the fabric supplied from the fabric supply unit is gradually folded with respect to the center line while moving, and a pressing unit configured to press the combined fabric.

### CROSS-REFERENCE TO RELATED APPLICATIONS

This application claims priority to Korean Patent Application No. 10-2025-0062992 filed on May 15, 2025, the entire contents of which are herein incorporated by reference.

### BACKGROUND

### 1. Field

The disclosure relates to an apparatus and a method for manufacturing a sensor pad. More particularly, the disclosure relates to an apparatus and a method for manufacturing a sensor pad used in a grip detection sensor that detects whether a driver grips a steering wheel in a capacitive method by placing a stretchable fabric type sensor layer and a shield layer and a dielectric layer therebetween.

### 2. Description of the Related Art

Autonomous vehicles perceive their surrounding environments by themselves without driver intervention and control vehicles by determining driving situations. Recently, these autonomous cars have attracted attention as means of transportation capable of reducing traffic accidents, increasing traffic efficiency, reducing fuel, and increasing driver convenience by replacing driving.

However, in some cases, driver intervention may be necessary depending on driving conditions. In such situations, vehicles in an autonomous driving mode need to immediately transfer control of the vehicles to drivers.

Therefore, autonomous cars need to check whether drivers are gripping steering wheels during autonomous driving, and need to warn the drivers for safety when the drivers do not grip the steering wheels when it is necessary to transfer control to the drivers.

In the related art, cameras or infrared sensors are used to detect whether drivers are gripping the steering wheels, but there are many cases of misrecognition depending on surrounding environments.

In addition, film sensors or metal wiring-based sensors are used in the related art, but the film sensors or the metal wiring-based sensors are not easy to attach to curved shapes of the steering wheels, and there is a high risk of disconnection or damage that occurs when the sensors themselves bend or stretch. In the case of fixed sensors in the form of a metal plate electrode, the sensors have low physical elasticity, which make drivers feel discomfort when the drivers grip steering wheels, causing inconvenience to the drivers or problems such as cover wear when the steering wheels are used for a long time.

### SUMMARY

Provided are an apparatus and a method for manufacturing a sensor pad in which with respect to a fabric in which a sensor layer and a shield layer are simultaneously woven, folding is naturally induced while the fabric passes through a guide unit, and, during this process, a dielectric layer is interposed and stably combined in a pressing unit at the same time, thereby efficiently manufacturing the sensor pad having a long lifespan without malfunctioning even in a curved surface or a region requiring expansion and contraction.

The solutions of the disclosure are not limited to the above-mentioned contents, and other technical problems not mentioned will be clearly understood by one of ordinary skill in the art from the following description.

According to an embodiment of the disclosure, an apparatus for manufacturing a sensor pad includes a fabric supply configured to supply, at a predetermined speed, a fabric with a sensor layer that is woven on one side and a shield layer that is woven on the other side with respect to a center line, a guide unit configured to guide the sensor layer and the shield layer to be naturally combined as the fabric supplied from the fabric supply unit is gradually folded with respect to the center line while moving, and a pressing unit configured to press the combined fabric.

The sensor pad may be a capacitive sensor pad.

The pressing unit may include a pair of pressing rollers, and the combined fabric may be pressed while passing between the pair of pressing rollers.

The guide unit may include a first guide unit configured to guide the fabric to be gradually folded as the fabric moves when an angle formed by a first surface in contact with the sensor layer and a second surface in contact with the shield layer gradually decreases in a moving direction of the fabric, and a second guide unit configured to guide the fabric to remain in a folded state and move when the first surface and the second surface are formed parallel to each other.

The apparatus may further include a dielectric layer supply unit configured to supply the dielectric layer so that the dielectric layer is interposed between the sensor layer and the shield layer during a process of folding the fabric by the guide unit.

The sensor layer of the fabric may include a sensing unit for detecting a driver's grip and a guard unit that is a region other than the sensing unit, the guard unit may be woven with a non-conductive yarn, and the sensing unit may be woven by including a conductive yarn.

The guide unit may include a folding induction unit configured to induce the fabric to be folded along the center line.

According to another embodiment of the disclosure, a method of manufacturing a sensor pad includes a fabric supply step of supplying, at a predetermined speed, a fabric with a sensor layer that is woven on one side and a shield layer that is woven on the other side with respect to a center line, a fabric combining step of combining the sensor layer and the shield layer by allowing the fabric supplied from a fabric supply unit to be gradually folded with respect to the center line while moving, and a fabric pressing step of pressing the combined fabric.

In the fabric pressing step, the fabric may pass through a guide unit including a first guide unit and a second guide unit, the sensor layer and the shield layer may be combined, the first guide unit may guide the fabric to be gradually folded as the fabric moves when an angle formed by a first surface in contact with the sensor layer and a second surface in contact with the shield layer gradually decreases in a moving direction of the fabric, and the second guide unit may guide the fabric to remain in a folded state and move when the first surface and the second surface are formed parallel to each other.

In the fabric pressing step, a dielectric layer may be interposed between the sensor layer and the shield layer during a process of folding the fabric by the guide unit.

### BRIEF DESCRIPTION OF THE DRAWINGS

FIG. 1 is a diagram illustrating a grip detection sensor mounted on a steering wheel;

FIG. 2 is a diagram illustrating a structure of a sensor pad manufactured according to an embodiment of the disclosure;

FIG. 3 is a photograph of a sensor layer according to an embodiment of the disclosure;

FIG. 4 is a diagram illustrating a guard unit that is woven only with a non-conductive yarn according to an embodiment of the disclosure;

FIG. 5 is a diagram illustrating a sensor unit that is woven by including a conductive yarn according to an embodiment of the disclosure;

FIG. 6 is a conceptual diagram illustrating an apparatus for manufacturing a sensor pad according to an embodiment of the disclosure;

FIG. 7 is a flowchart of a method of manufacturing a sensor pad according to an embodiment of the disclosure;

FIG. 8 is a diagram illustrating a fabric supplied by a fabric supply unit;

FIG. 9 is a diagram illustrating a process of folding a fabric passing through a guide unit of the disclosure; and

FIG. 10 is a side view of a guide unit according to an embodiment of the disclosure and a cross-sectional view of the guide unit according to each position.

### DETAILED DESCRIPTION

The disclosure will now be described more fully with reference to the accompanying drawings, in which embodiments of the disclosure are shown. These embodiments are provided so that the disclosure will be thorough and complete, and will fully convey the concept of the disclosure to those of skill in the art. The disclosure may, however, be embodied in many different forms and should not be construed as being limited to the embodiments set forth herein. For clarity, portions that are not relevant to the description of the present disclosure are omitted.

The terms used in the present specification are merely used to describe particular embodiments of the disclosure, and are not intended to limit the disclosure. An expression used in the singular encompasses the expression of the plural, unless it has a clearly different meaning in the context.

In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the present disclosure will be thorough and complete, and will fully convey the concept of the disclosure to those skilled in the art. In the drawings, sizes and thicknesses of components may be exaggerated for clarity.

Hereinafter, the disclosure will be described in detail with reference to the attached drawings.

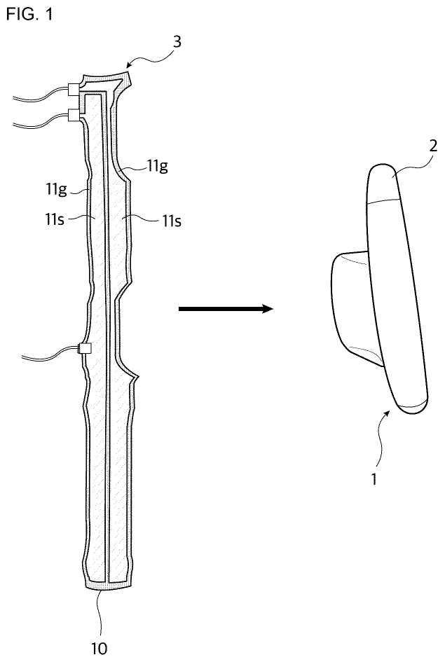

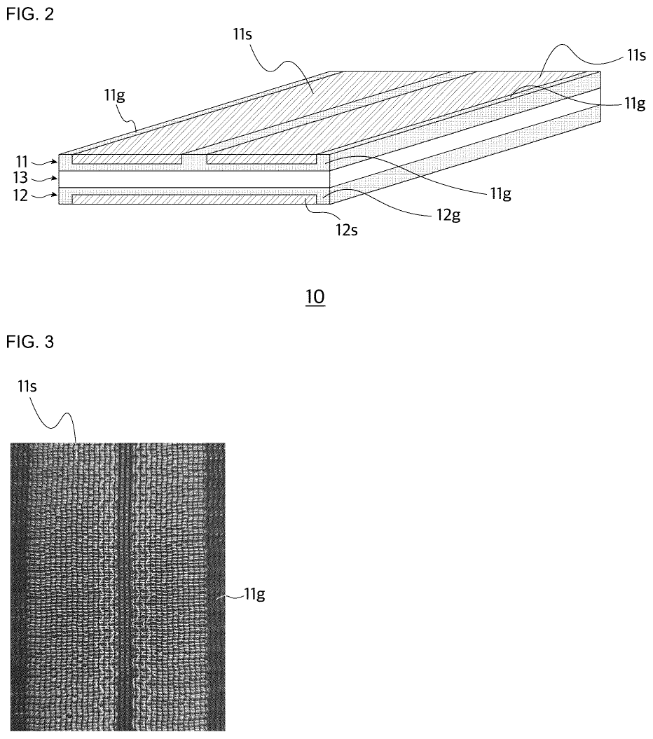

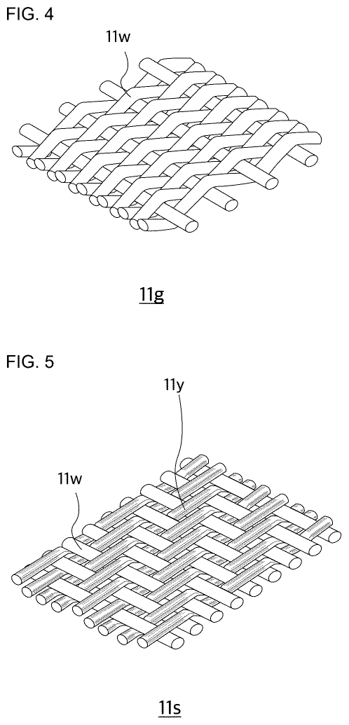

FIG. 1 is a diagram illustrating a grip detection sensor mounted on a steering wheel. FIG. 2 is a diagram illustrating a structure of a sensor pad manufactured according to an embodiment of the disclosure. FIG. 3 is a photograph of a sensor layer according to an embodiment of the disclosure. FIG. 4 is a diagram illustrating a guard unit that is woven only with a non-conductive yarn according to an embodiment of the disclosure. FIG. 5 is a diagram illustrating a sensor unit that is woven by including a conductive yarn according to an embodiment of the disclosure.

Referring to FIGS. 1 to 5, an apparatus for manufacturing a sensor pad 10 according to an embodiment of the disclosure is for manufacturing the sensor pad 10 applied to a grip detection sensor 3 detecting whether a rim 2 of a steering wheel 1 is gripped. The grip detection sensor 3 is a capacitive sensor, and may be mounted on the rim 2 to surround the rim 2.

The sensor pad 10 manufactured by the apparatus of the disclosure may include a stretchable fabric type sensor layer 11 and a shield layer 12, and a dielectric layer 13 disposed therebetween. The sensor layer 11 and the shield layer 12 may be woven with non-conductive yarns 11w but may respectively include a sensor unit 11s and a shield unit 12s that include and are woven with conductive yarns 11y for serving as electrodes. As shown in FIG. 4, a portion that is woven only with the non-conductive yarn 11w may be understood as a guard unit 11g, and as shown in FIG. 5, a portion that includes and is woven with the conductive yarn 11y may be understood as the sensor unit 11s or the shield unit 12s. The dielectric layer 13 may be disposed between the sensor layer 11 and the shield layer 12 to form a gap such that the two layers are not in direct electrical contact. The dielectric layer 13 may be formed of a material having insulation and flexibility, such as a polyimide film, a synthetic resin film, or a foam.

The grip detection sensor 3 mounted on the rim 2 may detect a grip state by measuring a change in a capacitance between the sensor unit 11s of the sensor layer 11 and the shield unit 12s of the shield layer 12 that occurs when a driver grips the rim 2.

That is, the sensor unit 11s and the shield unit 12s operate as both electrodes of a capacitor, to determine whether the driver grips the rim 2 through the capacitance formed between the two electrodes. One sensor unit 11s and shield unit 12s constitute one capacitor, and the capacitance varies when a driver's hand contacts the sensor unit 11s, and thus, the grip detection sensor 3 may identify the grip state.

Specifically, when the driver grips the rim 2 on which the grip detection sensor 3 is mounted, a driver's palm is electrically linked to the sensor unit 11s serving as an electrode, so that the grip detection sensor 3 may operate as if the sensor unit 11s has a larger area. When an effect of increasing the area of the sensor unit 11s occurs, the capacitance measured by being formed between the sensor unit 11s and the shield unit 12s increases, and when an increasing value is greater than or equal to a preset threshold, the grip detection sensor 3 may determine that the hand is gripping the rim 2.

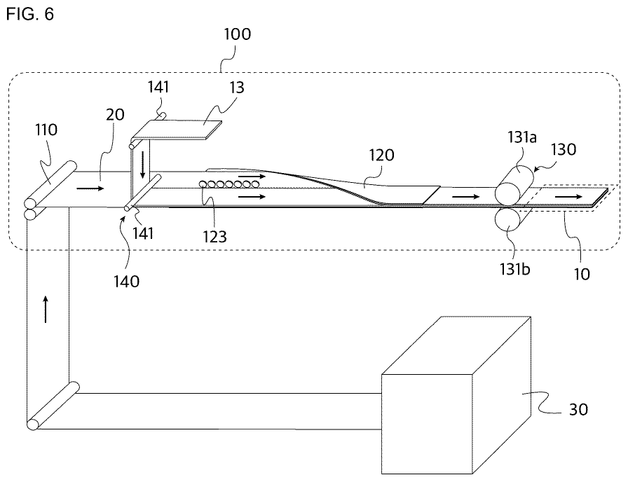

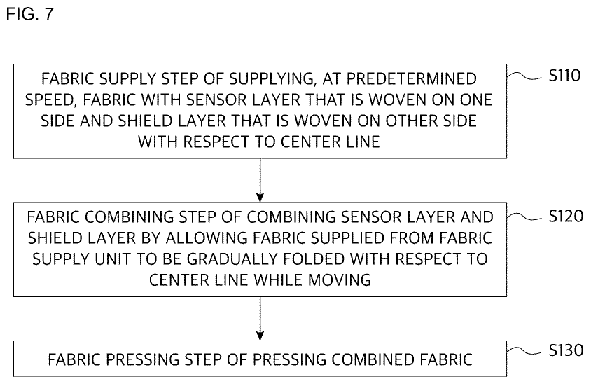

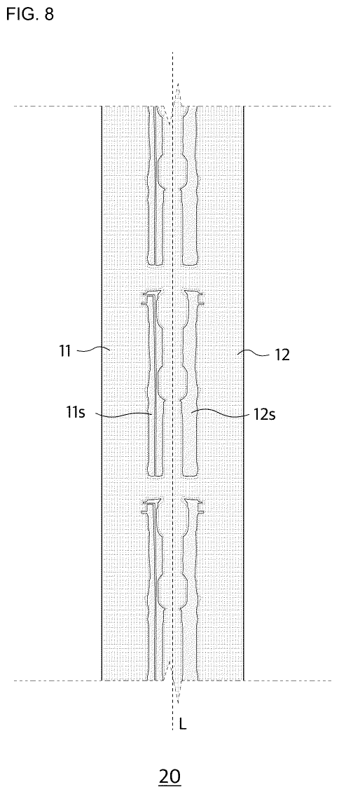

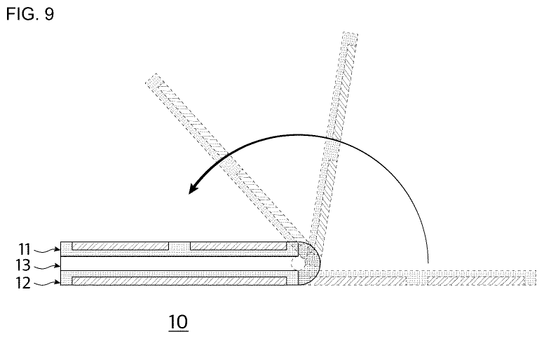

FIG. 6 is a conceptual diagram illustrating an apparatus for manufacturing a sensor pad according to an embodiment of the disclosure. FIG. 7 is a flowchart of a method of manufacturing the sensor pad according to an embodiment of the disclosure. FIG. 8 is a diagram illustrating a fabric supplied by a fabric supply unit. FIG. 9 is a diagram illustrating a process of folding a fabric passing through a guide unit of the disclosure.

Referring to FIGS. 6 to 9, an apparatus 100 for manufacturing the sensor pad according to an embodiment of the disclosure is an apparatus for performing the method of manufacturing the sensor pad, and may include a fabric supply unit 110, a guide unit 120, and a pressing unit 130. The method of manufacturing the sensor pad according to an embodiment may include a fabric supply step S110, a fabric combining step S120, and a fabric pressing step S130.

The fabric supply unit 110 is for performing the fabric supply step S110 of supplying a fabric 20 that is woven with the sensor layer 11 and the shield layer 12 to the guide unit 120. The fabric supply step S110 may be a step of supplying the fabric 20 at a predetermined speed.

In an embodiment, the fabric supply unit 110 may be configured as one or more rollers to unwind and pull the fabric 20 and supply the fabric 20 to the guide unit 120 at the predetermined speed. The fabric supply unit 110 may maintain the tension and transfer speed of the fabric 20 by monitoring a progress speed and tension of the fabric 20 with a sensor and controlling the rotational speed of the roller to prevent the fabric 20 from being supplied too fast or from being loose.

Here, the fabric 20 is woven by a weaving apparatus 30, and may be woven to include the sensor layer 11 and the shield layer 12. Referring to FIG. 8, the sensor layer 11 may be woven on one side of the fabric 20 with respect to a center line L in a longitudinal direction, and the shield layer 12 may be woven on the other side. The sensor layer 11 and shield layer 12 that are woven may be symmetrical to each other with respect to the center line L in the longitudinal direction.

The guide unit 120 is for performing fabric combining step S120 of combining the sensor layer 11 with the shield layer 12 by folding the fabric 20 in a process of moving the fabric 20 supplied from the fabric supply unit 110. The fabric 20 passing through the guide unit 120 may be gradually folded with respect to the center line L according to the shape of the guide unit 120 so that the sensor layer 11 and the shield layer 12 may be naturally combined. For example, as shown in FIG. 9, the fabric 20 may pass through the guide unit 120 and a region of the sensor layer 11 may be folded by an inclined surface of the guide unit 120 and overlap over the shield layer 12.

In an embodiment, the guide unit 120 may include a folding induction unit 123 that induces the fabric 20 to be folded along the center line L. The folding induction unit 123 is one or more rollers, and may be disposed to engage with a point of the center line L of the fabric 20 continuously entering the guide unit 120. The fabric 20 that has entered the guide unit 120 may move in a traveling direction, and the region of the sensor layer 11 may be lifted and folded according to the shape of the guide unit 120. In this regard, because the fabric 20 is pressed when the center line L is engaged with the folding induction unit 123, a region of the fabric 20 that is folded according to the shape of the guide unit 120 may be limited to the center line L. Because the fabric 20 is folded along the center line L due to the folding induction unit 123, the sensor layer 11 and the shield layer 12 that are symmetrical with respect to the center line L may be overlapped so that the sensor unit 11s and the shield unit 12s correspond to each other.

In addition, the folding induction unit 123 presses the center line L of the fabric 20, and thus, the fabric 20 may move in an aligned position state without moving out of alignment.

The pressing unit 130 is for performing the fabric pressing step S130 of pressing, at a constant pressure, the fabric 20 that is combined by passing through the guide unit 120, so as to make each layer of the combined fabric 20 uniformly adhere to each other. In an embodiment, the pressing unit 130 may include a pair of pressing rollers 131a and 131b. The first pressing roller 131a and the second pressing roller 131b may face each other, and the sensor pad 10 may be manufactured by pressing the fabric 20 passing therebetween.

In an embodiment of the disclosure, the apparatus 100 for manufacturing the sensor pad may further include a dielectric layer supply unit 140. The dielectric layer supply unit 140 may supply the dielectric layer 13 so that the dielectric layer 13 is interposed between the sensor layer 11 and the shield layer 12 in the fabric combining step S120. For example, the dielectric layer supply unit 140 may include a plurality of guide rollers 141 that transfer the dielectric layer 13 at a constant tension and speed and guide a supply path. The dielectric layer supply unit 140 may be disposed at or immediately before a point where the sensor layer 11 and the shield layer 12 are gradually folded with respect to the center line through the guide unit 120 to supply the dielectric layer 13 so that the dielectric layer 13 may be seated on the sensor layer 11 simultaneously with a folding process.

As described above, the dielectric layer 13 supplied through the dielectric layer supply unit 140 may be interposed between the sensor layer 11 and the shield layer 12 folded with respect to the center line, and the combined fabric 20 together with the dielectric layer 13 may be discharged from an exit of the guide unit 120 and transferred to the pressing unit 130.

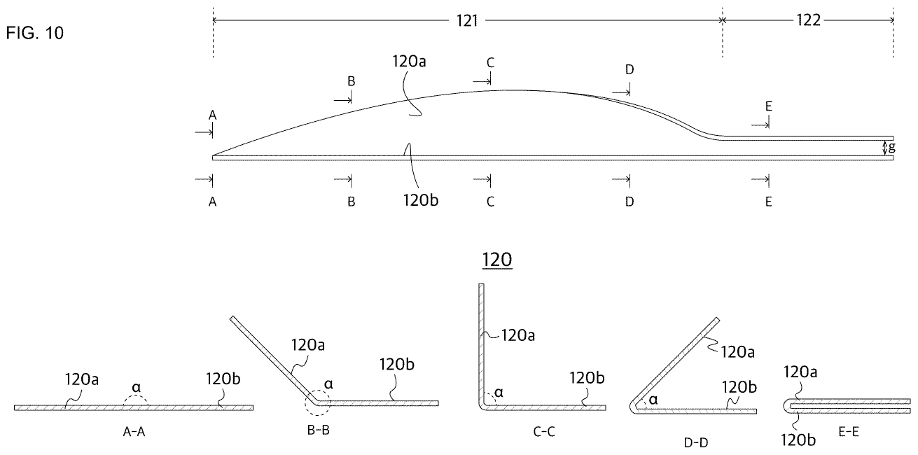

FIG. 10 is a side view of a guide unit according to an embodiment of the disclosure and a cross-sectional view of the guide unit according to each position.

Referring to FIGS. 6 to 10, the guide unit 120 performing the fabric combining step S120 according to an embodiment of the disclosure may guide the fabric 20 to be folded step by step while moving and maintain a stable folded state, and may include a first guide unit 121 and a second guide unit 122. The first guide unit 121 and the second guide unit 122 may include a first surface 120a in contact with the sensor layer 11 and a second surface 120b in contact with the shield layer 12 when the fabric 20 enters the guide unit 120.

In the first guide unit 121, an angle α formed by the first surface 120a and the second surface 120b may gradually decrease in a moving direction of the fabric 20. Referring to FIG. 10, the first surface 120a and the second surface 120b may be horizontal to each other at a point a, which is an initial period of the first guide unit 121. In a traveling direction of the fabric 20, the angle α of each of points b, c, and d may decrease. For example, the angle α at the point a may be 180 degrees, the angle α at the point b may be 135 degrees, the angle α at the point c may be 90 degrees, and the angle α at the point d may be 45 degrees. The fabric 20 entering the first guide unit 121 may be guided to proceed by being placed on the first surface 120a and the second surface 120b so that the fabric 20 may be naturally folded along the first surface 120a. In this regard, each of the first surface 120a and the second surface 120b may be formed to have a smooth curved structure to induce the fabric 20 to be gradually folded.

The second guide unit 122 is for guiding the fabric 20 to remain folded and move, may be formed to extend from the first guide unit 121, but the first surface 120a and the second surface 120b may be formed parallel to each other. The angle α decreased by passing through the first guide unit 121 may be 0 degrees in the second guide unit 122 so that the first surface 120a and the second surface 120b may be parallel to each other. However, the first surface 120a and the second surface 120b may not be in contact with each other, and a gap g may be formed therebetween. The fabric 20 folded by passing through the first guide unit 121 may move along the gap g in a folded state.

The second guide unit 122 may support the folded fabric 20 in which the first surface 120a and the second surface 120b are folded on both sides, thereby preventing the folded state of the fabric 20 from being shaken or unwound and fixing a folded part of the fabric 20. In addition, when the length of the second guide unit 122 is sufficiently secured, after the folding of the fabric 20 remains stable, the fabric 20 may be synchronized so as to be inserted into the pressing unit 130.

The apparatus and the method for manufacturing the sensor pad of the disclosure may manufacture a flexible sensor pad that is easily attachable to a curved surface or a complex shape such as a steering wheel through a process of weaving a sensor layer and a shield layer in the form of a fabric and naturally folding and combining the fabric.

In addition, the apparatus and the method for manufacturing the sensor pad may gradually induce the folding of the fabric through a guide unit and maintain the folded fabric in a parallel state, thereby obtaining a sensor pad of uniform quality without wrinkles or twists of the fabric even at a fast production rate.

According to an embodiment of the disclosure, with respect to a fabric in which a sensor layer and a shield layer are simultaneously woven, folding is naturally induced while the fabric passes through a guide unit, and, during this process, a dielectric layer is interposed and stably combined in a pressing unit at the same time, the apparatus and the method for manufacturing the sensor pad may efficiently manufacture the sensor pad having a long lifespan without malfunctioning even in a curved surface or a region requiring expansion and contraction.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. An apparatus for manufacturing a sensor pad, the apparatus comprising:
a fabric supply unit configured to supply, at a predetermined speed, a fabric with a sensor layer that is woven on one side and a shield layer that is woven on the other side with respect to a center line;
a guide unit configured to guide the sensor layer and the shield layer to be naturally combined as the fabric supplied from the fabric supply unit is gradually folded with respect to the center line while moving; and
a pressing unit configured to press the combined fabric.

2. The apparatus of claim 1, wherein the sensor pad is a capacitive sensor pad.

3. The apparatus of claim 1, wherein
the pressing unit includes a pair of pressing rollers, and
the combined fabric is pressed while passing between the pair of pressing rollers.

4. The apparatus of claim 1, wherein the guide unit includes
a first guide unit configured to guide the fabric to be gradually folded as the fabric moves when an angle formed by a first surface in contact with the sensor layer and a second surface in contact with the shield layer gradually decreases in a moving direction of the fabric; and
a second guide unit configured to guide the fabric to remain in a folded state and move when the first surface and the second surface are formed parallel to each other.

5. The apparatus of claim 1, further comprising: a dielectric layer supply unit configured to supply the dielectric layer so that the dielectric layer is interposed between the sensor layer and the shield layer during a process of folding the fabric by the guide unit.

6. The apparatus of claim 1, wherein
the sensor layer of the fabric includes a sensing unit for detecting a driver's grip and a guard unit that is a region other than the sensing unit,
the guard unit is woven with a non-conductive yarn, and the sensing unit is woven by including a conductive yarn.

7. The apparatus of claim 1, wherein the guide unit includes a folding induction unit configured to induce the fabric to be folded along the center line.

8. A method of manufacturing a sensor pad, the method comprising:
a fabric supply step of supplying, at a predetermined speed, a fabric with a sensor layer that is woven on one side and a shield layer that is woven on the other side with respect to a center line;
a fabric combining step of combining the sensor layer and the shield layer by allowing the fabric supplied from a fabric supply unit to be gradually folded with respect to the center line while moving; and
a fabric pressing step of pressing the combined fabric.

9. The method of claim 8, wherein
in the combining step, the fabric passes through a guide unit including a first guide unit and a second guide unit, and the sensor layer and the shield layer are combined,
the first guide unit is configured to guide the fabric to be gradually folded as the fabric moves when an angle formed by a first surface in contact with the sensor layer and a second surface in contact with the shield layer gradually decreases in a moving direction of the fabric, and
the second guide unit is configured to guide the fabric to remain in a folded state and move when the first surface and the second surface are formed parallel to each other.

10. The method of claim 9, wherein, in the fabric pressing step, a dielectric layer is interposed between the sensor layer and the shield layer during a process of folding the fabric by the guide unit.
